(19) United States
(12) Patent Application Publication
(10) Pub. No.: US 2007/0284487 A1
(43) Pub. Date: Dec. 13, 2007

(54) Device, system and method for reducing repetitive injury

(76) Inventor: Robert G. Dalecki, Indiana, PA (US)

Correspondence Address: Parrish Law Offices, 615 Washington Road, Suite 200, Pittsburgh, PA, 15228, US

(21) Appl. No.: 11/810,809

(22) Filed: Jun. 7, 2007

Related U.S. Application Data
(60) Provisional application No. 60/811,532, filed on Jun. 7, 2006.

(51) Int. Cl. B43L 15/00

(52) U.S. Cl. 248/118.1

(57) ABSTRACT

A device for operating a computer mouse comprises a platform having a holding area, preferably a recess, in the platform in which a computer mouse may be operated. The platform should be of a sufficient length and width for the computer operator's forearm to rest thereon. A cushion may be added to the platform. The device should be mounted to adjust longitudinally along and rotate axially about an armchair for either left- or right-handed mouse use. A related system and method are also disclosed.

### CROSS-REFERENCE TO RELATED APPLICATIONS

This application claims the benefit of priority to U.S. Provisional Application Ser. No. 60/811,532, filed on Jun. 7, 2006 and fully incorporated by reference herein.

### FIELD OF THE INVENTION

The present invention relates to an ergonomic device and system for computer mouse usage that prevents common injuries, and to a method of preventing repetitive injuries associated with computer mouse usage.

### BACKGROUND OF THE INVENTION

With the advent of mass personal computer usage, the incidence of repetitive injury disorders such as carpal tunnel syndrome has proliferated to the point of becoming the number one work related injury. It typically manifests itself with symptoms such as pain, numbness and/or stiffness in the hands, wrist, arm, shoulder and neck. Carpal tunnel syndrome has also been known to cause a loss of range of motion in the shoulder as well as loss of grip strength of the hand. Typically, treatments for carpal tunnel syndrome may range from noninvasive techniques such as physical therapy that includes joint manipulation, ultrasound, icing and electro-muscle stimulation, to ingestion of anti-inflammatory drugs, and to invasive procedures such as surgery for removing scar tissue within the wrist that impinges the median nerve. Therefore, a need exists to find means to permit a user to operate a computer in a comfortable and ergonomic fashion, which will prevent such a disabling injury.

A similar ailment, wrist tendonitis, has also been associated with computer use. The carpal tunnel is a narrow passageway in one's wrist through which the median nerve passes. This nerve carries sensations for the entire hand. It also affects the finger flexor tendons, which link one's fingers to the muscles in the person's lower arm. The tunnel is formed by walls of solid bone on three sides with the bottom enclosed by the transverse carpal ligament, a tough, inelastic cartilage. Carpal tunnel syndrome occurs when the tendons protect themselves from overuse. Each tendon is surrounded by a thick fluid-filled sac called a synovial sheath, which swells with extra fluid to protect the tendon. Scientifically, this swelling is called tendonitis. When these sacs swell in the carpal tunnel, they can pinch the median nerve against the bones or the carpal ligament. The result can be loss of sensation in the hands and debilitating pain.

Using computers physically involve repetitive tasks, such as gripping, pushing and reaching for items such as the keyboard and pointing device. This is because the position of the user relative to the keyboard often requires the extension of upper extremities, such as the neck and shoulder, as well as the arms and hands from the seating apparatus to the mouse. This lack of optimum positioning, coupled with the highly repetitive nature required for mouse use, results in the aforementioned cumulative trauma injury. Efforts to decrease the stresses placed on the computer operator usually take place only after the symptoms have occurred. The need for a preventative support for the upper extremities and wrist of the operator has become more evident as more repetitive motion and stress related injuries occur.

Basic use of a computer mouse on a surface provided by a table, for example, requires positioning the user's hand in a generally horizontal position which can cause the tendons in the hand to lie in strained positions, often resulting in discomfort. Use of the tendons in this position can exacerbate such discomfort and may result in irritations of the carpal tunnel in some users. An invention allowing a computer user to grasp a computer mouse with the wrist in a more natural upright position is needed. Such an invention will reduce the amount of stress and swelling of the synovial sheath, thereby reducing the operator's chances of sustaining a repetitive stress injury.

Tables that mount to the arm of a chair exist, but do not tilt to the right or left about the X-axis, or in the same plane as the Z-axis. The present invention creates a more neutral upright position for a computer user's hand, wrist and forearm, while using a mouse alleviates tensions found in the carpal tunnel.

Other devices involve more complex systems and may require specialized chairs. For example, U.S. Pat. No. 5,884,974 (Bergstern et al) describes a chair having armrests for supporting wrists which are adjustable in height, pivotal and longitudinally slidable. Unlike the present invention, this device neither rotates the wrist into a natural position nor does it position the user's elbow below the shoulder.

Similarly, U.S. Pat. No. 6,648,282 (Sykes) does not rotate the computer user's hand, wrist and forearm into a more natural upright position.

U.S. Pat. No. 5,730,408 (McAllister, et al) describes a workstation support for a keyboard and a mouse. This device does not position the wrist in the preferred natural position. This device forces the user to lean forward out of the chair, which places stress on the upper back and neck.

### SUMMARY OF THE INVENTION

The present invention relates to a device and system affording an adjustable armrest for use with a personal computer. More particularly, the present invention pertains to a device and system designed to relieve symptoms associated to repetitive motion syndrome (RMS) of the fingers while using a computer-pointing device.

Computer users often suffer many maladies during extensive use of a mouse. Users often find themselves bracing their arm against the sharp edge of a desktop while using a mouse. This results in an uncomfortable pressure placed on the wrist and lower forearm.

Numerous wrist pads, wrist supports, arm supports, and ergonomic methods known in the art have addressed the problem of providing comfortable use of a computer mouse, but none have proven fully effective. Thus, there exists a need for a device that will allow the computer user to comfortably use their mouse while preventing pains in the wrist and forearm.

This invention is a device, system and method designed to relieve symptoms associated to repetitive strain injury of the hand, wrist and forearm while using a computer mouse. The present invention comprises a platform having a holding area, either a recess or raised lip region, and a mounting mechanism. The platform preferably is made of wood, metal or plastic and has a mounting means for attaching the platform to an arm of a seating venue such as a chair. The device is mounted using brackets designed to allow the platform to tilt to the right (or left if the operator is left-handed) about the X-axis. This tilting motion permits a user's hand, wrist and arm to rest in a more neutral position while holding a computer mouse, thus greatly reducing the stresses within the wrist. These stresses are the leading cause for incidence of repetitive strain injury.

The platform contains a recess at one end of the platform proximally located closest to the computer. The computer pointing device, i.e., the mouse, substantially resides in the recess when the mouse is being used. The recess is of sufficient depth to reduce the proclivity of the mouse from falling off the platform when the mouse is not being used. In a system of the present invention, the mouse is cordless.

This invention is an ergonomic device, system and method for relieving stress to the upper back and neck. While using a computer mouse the conventional position of a user's arm is extended in front of the body, which places stress on the upper back and neck area. The present invention relieves such stresses by allowing the user's arms to reside closer to the user's side and allowing the user's elbow to remain below the shoulder. To allow a more perfect fit for a user's arms, the platform can be adjusted longitudinally, i.e. along the X-axis (as indicated in accompanying FIG. 1A), to be either more proximal or distal to the seating device upon which the computer mouse platform is mounted.

Because computers which use a mouse or other data input device become more common, the workspace of an existing office is increasingly more crowded due to the presence of added computer equipment. It is, therefore, often necessary to purchase additional furniture to provide work surfaces on which to deploy the computer equipment. This is particularly true where the data input device uses a mouse, a track ball or a digitizer tablet in addition to the keyboard found in a personal computer or a computer workstation system. The device of this invention alleviates such problems.

### BRIEF DESCRIPTION OF THE DRAWINGS

Still other objectives and advantages of the present invention will become apparent to those skilled in the art after reviewing the detailed description that follows made with reference to accompanying drawings in which:

FIG. 1A is a perspective view showing one preferred embodiment of device according to this invention;

FIG. 1B is a perspective view showing an alternate device embodiment with a raised lip region instead of a platform recess;

FIG. 2A is a top schematic view showing the device of FIG. 1A;

FIG. 2B is a bottom schematic view of the FIG. 1A device with the mounting means removed;

FIG. 3 is a side schematic view of the FIG. 1A device;

FIG. 4 is an exploded partial side view taken along lines IV-IV of FIG. 2A;

FIG. 5A is a perspective view of a first alternative mounting bracket means for use with the present invention; and

FIG. 5B is a perspective view of a second alternative mounting bracket means for use with same.

### DETAILED DESCRIPTION OF PREFERRED EMBODIMENTS

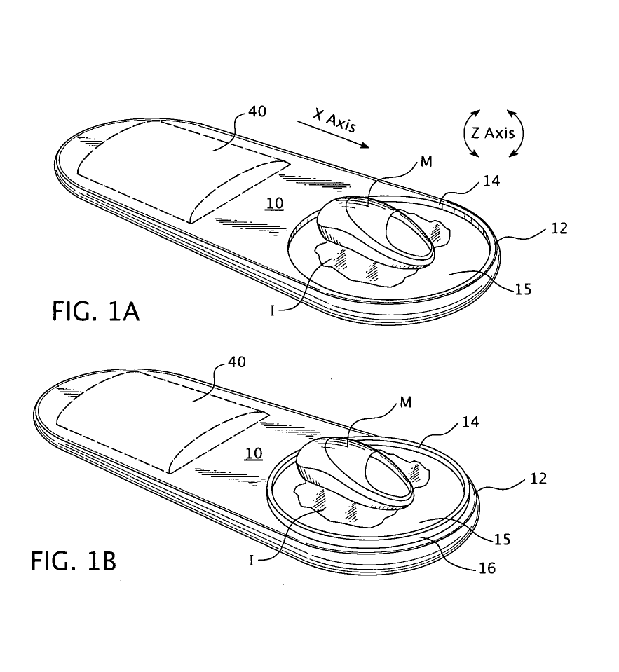

Referring now to the accompanying FIGURES, the device of the present invention comprises a substantially planar surface, or platform 10 having at its forward end 12 a mouse holding area 14. That area should include a substantially planar region 15 about which a computer optical mouse, preferably a cordless mouse M, may be manipulated or allowed to rest when not in use. In one preferred embodiment, mouse holding area 14 is a slight recess or detent into platform as per FIG. 1A. Alternately, mouse holding area 14 may exist in substantially the same plane as platform 10 but separated by a raised lip region 16 as better seen in FIG. 1B. Preferred embodiments allow for a coating surface on the mouse holding area 14 for easier mouse movement, operation and/or maintenance. In more preferred embodiments, holding area 14 may be fitted with a changeable insert I in which a photograph or promotional logo may be inserted and over which the mouse may still be operated. Whether recessed into the platform, or separated from platform 10 by a raised lip 16, mouse holding area 14 is intended to reduce the proclivity of the computer mouse from falling out of that area and off platform 10 when the mouse is not being used.

The device further includes means for mounting platform 10 to a computer operator/user seating venue such as an armchair (not shown). Preferably, platform 10 is made of wood, metal, plastic or combinations of same. Most preferably, for aesthetics and feel, platform 10 is made from a well varnished, stained wood. That planar surface is mounted to the arm of the seating venue, most preferably a computer desk chair. The planar surface is attached to the seating venue in a manner that allows tilting or rotation about the same X-axis, and in the same plane as the Z-axis (per FIG. 1A), when affixed to the right or left arm of a computer desk chair depending on whether the computer mouse operator is predominantly right- or left-handed.

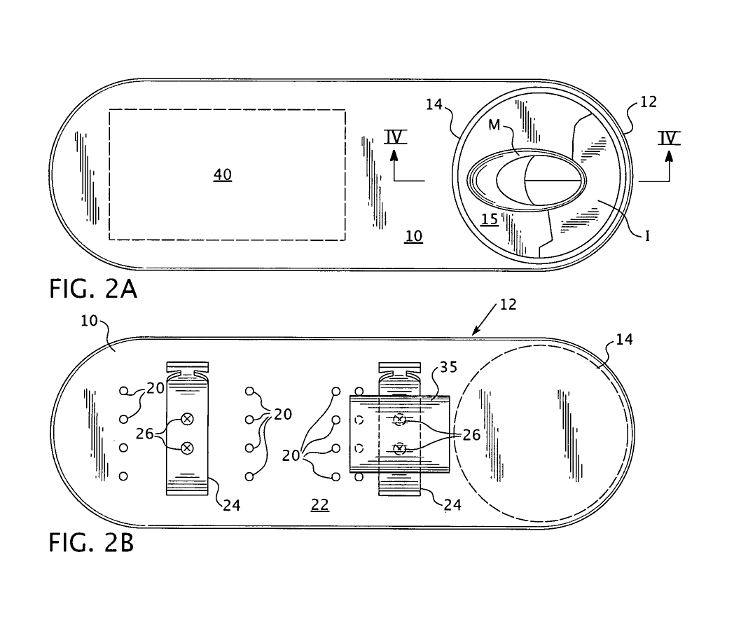

One preferred mechanism for accomplishing such mounting includes a plurality of spaced apertures 20 into the underside 22 of platform 10 as better seen in accompanying FIG. 2B. Such apertures serve as pre-configured receptacles for receiving a plurality of preferred bracketing attachments 24 described in greater detail hereinafter. Each bracketing attachment 24 is shown with two sets of screw holes 26 for accommodating use by an operator who is either right or left-handed. Each set of screw holes includes a plurality of positions for accommodating an armrest on the variety of chairs/seating venues currently being commercially offered.

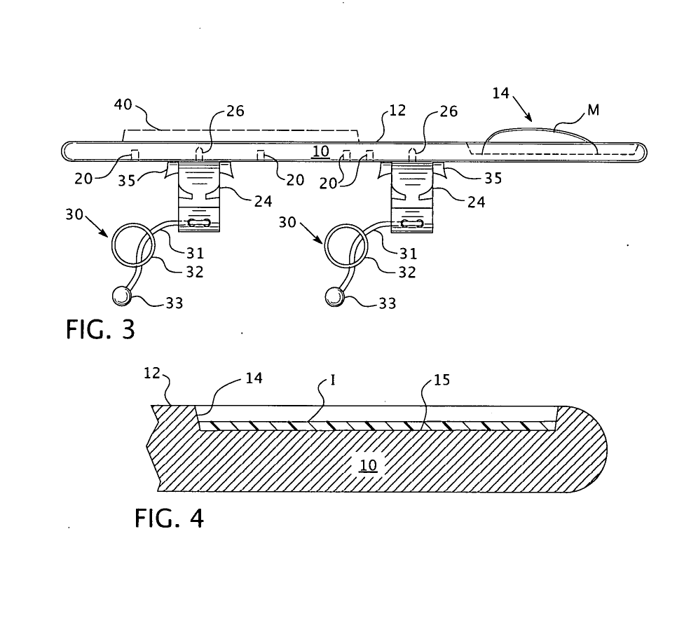

It is preferred that the platform be secured to the left or right arm of the computer operator's armchair in a tension-promoting arrangement. One means for accomplishing supplemental securement is to position a twistable shock cord clip 30 for stretching under the arm of the armchair and securing at either end to preferred platform mounting means, or bracket 24. In this embodiment, each bracket 24 is made from a half section of roughly four inch diameter ABS plastic coupling for creating an arch arrangement. The inside of this half section rides on the arm of the seating venue/armchair. More preferably, a piece of thick protective fabric or textile 35 can be fixedly attached to, or subsequently inserted on the inside arch of each bracket before or after mounting to protect the seating venue material from possible disfigurement by the invention. See, the right bracket in FIG. 2B and the inserted fabric 35 in both brackets of FIG. 3.

As best seen in FIG. 3, each shock cord clip 30 include an elastic cord 31, that is threaded through a section of three inch diameter ABS tubing 32, before ending in a knot or knotted ball 33. Such a clip configuration quickly connects to an end of bracket 24. For increasing the amount of pressure applied against bracket 24, the tubing component of clip 30 can be twisted from beneath the arm of the chair to which platform 10 will be fastened.

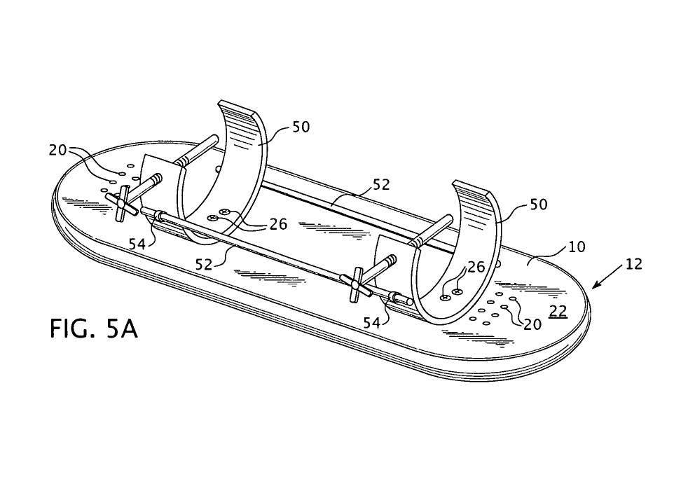

One preferred embodiment of the system of the present invention includes a cushion 40 (shown in silhouette in FIGS. 1A through 4). Cushion 40 would be appended to platform 10 for protecting the mouse user/operator from abrasion. It can be made of any soft and durable material. In one embodiment, cushion 40 includes a one half-inch section of foam beneath a washable outer covering. As such, cushion 40 should be removably attached to platform 10. One such method of cushion attachment employs hook-and-eye tape, also more commonly known as Velcro® tape (not shown). In that embodiment, a first strip of Velcro® tape is attached to the underside of the cushion and the corresponding, complementary strip of Velcro® tape (either the hook or eye portion) is attached to the uppermost platform surface.

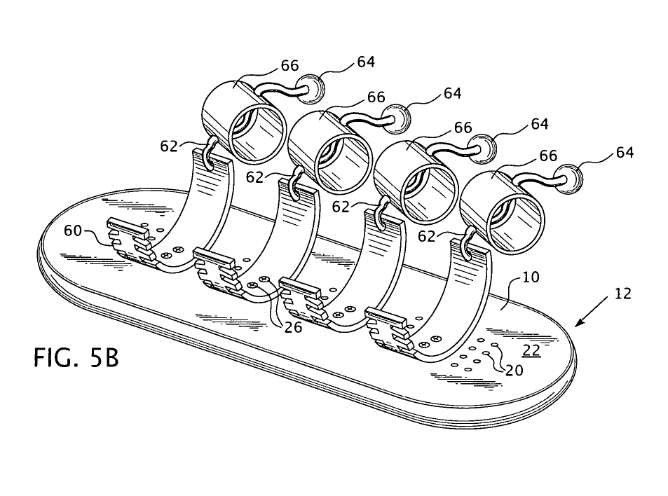

Alternately, platform 10 may mount to the arm of a deskchair with a plurality of (preferably two) screw clamp brackets, item 50 in FIG. 5A. Should some longitudinal adjustment be desired, the mounting means may include a plurality of longitudinally extending rods 52 for fitting into and between rod mounting clamps 54 on the brackets proper. This mounting means is a viable option when less axial rotation about the X-axis is critical.

Referring now to FIG. 5B, still other mounting means may include a plurality of multi-tined brackets 60, about which a plurality of shock cord-like devices 62 may wind about after proper positioning on the left or right arm of a computer desk chair. To better tension these mounting means about the armchair, each shock cord knot 64 may be loosened and its corresponding shock cord tubing 66 twisted.

The dimensions of the preferred embodiments are by way of example only, and are in no way to be considered limiting. By way of example and not limitation, components of this device and system may be made from a variety of aesthetically pleasing materials including wood, stainless steel, aluminum, plastic, composites and/or any other material which has sufficient material properties to structurally support the arm and a computer mouse proximal to a computer. Other materials may be desirable and are considered within the scope of this discussion.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention.

What is claimed is:

1. A device for operating a computer mouse, said device comprising:
a platform having a holding area in which a computer mouse may be operated or in which the mouse may rest when not in use, said platform being of a sufficient length and width for a computer operator's arm below the elbow to substantially rest thereon; and
means for pivotally mounting the platform to an arm of a chair for either left- or right-handed operator mouse use.

2. The device of claim 1, wherein the holding area is located at a forward end of the platform.

3. The device of claim 1 which further includes a forearm cushion component.

4. The device of claim 3, wherein said cushion component is removably attached to the platform.

5. The device of claim 4, wherein said cushion component attaches to the platform with a plurality of hook-and-eye tape sections.

6. The device of claim 1, wherein an underside of said platform includes a plurality of apertures into which mounting brackets may be inserted after positioning about the chair of the arm.

7. The device of claim 1, wherein said platform mounting means includes at least two flexible brackets for attaching about the chair of the arm and to an underside of said platform.

8. The device of claim 7 which further includes an armchair cushion for positioning between the arm and each flexible bracket.

9. The device of claim 1 which further includes a changeable insert for the recess.

10. The device of claim 1, wherein said platform is made from a material selected from the group consisting of: wood, a metal, a polymer, a composite and combinations thereof.

11. The device of claim 10, wherein said holding area is a recess in the platform.

12. A system for reducing repetitive injury from an operator use of a computer mouse at a workstation having an armchair, said system comprising:
a platform affixed to the armchair, said platform having a holding area for the computer mouse and being of a sufficient length and width for the operator to rest his or her forearm thereon; and
means for mounting the platform to the armchair so as to rotate to a desired operator position about an X-axis and adjust longitudinally along the armchair.

13. The system of claim 12, wherein the desired position is a natural wrist and arm position.

14. The system of claim 12 which further includes a forearm cushion component.

15. The system of claim 12, wherein an underside of said platform includes a plurality of apertures into which flexible brackets may be inserted after positioning about the armchair.

16. The system of claim 15 which further includes an armchair cushion for positioning between the armchair and flexible bracket.

17. The system of claim 12, wherein said holding area is a recess in the platform.

18. The system of claim 12, wherein said platform is made from a material selected from wood, a metal, a polymer and combinations thereof.

19. A method for reducing repetitive injury from an operator use of a computer mouse at a workstation having an armchair, said method comprising:
(a) pivotally mounting to the left or right arm of the armchair (depending on whether the operator is left or right handed, a platform having a holding area for the mouse, said platform being of a sufficient length and width for the operator to rest his or her forearm thereon; and
(b) adjusting the platform longitudinally along and pivotally about an X-axis for the computer operator.

20. The method of claim 19 which further includes: (c) positioning a removable cushion beneath the forearm of the operator.
